(19) United States
(12) Patent Application Publication
(10) Pub. No.: US 2017/0038828 A1
(43) Pub. Date: Feb. 9, 2017

(54) Timeline-Based Three-Dimensional Visualization Of Video Or File Content

(71) Applicant: Yen-Ting Cho, Hsinchu (TW)

(72) Inventors: Yen-Ting Cho, London (GB); Yen-Ling Kuo, Sunnyvale, CA (US); Yen-Ting Yeh, Taoyuan (TW)

(21) Appl. No.: 14/816,869

(22) Filed: Aug. 3, 2015

(51) Int. Cl. G06F 3/01; G06T 19/20; G06T 17/20

(52) U.S. Cl. CPC G06F 3/011; G06T 17/20; G06T 19/20; G06T 2219/2004; G06T 2219/2016

(57) ABSTRACT

Methods and devices pertaining to timeline-based three-dimensional visualization of video or file content are described. A method may involve establishing, in a virtual space, a first three-dimensional structure representative of a content of a data stream. The first three-dimensional structure may have a time axis representative of a timeline. The method may also involve establishing, in the virtual space, a second three-dimensional structure representative of a model of a body of a user. The method may further involve displaying at least a first portion of the content of the data stream along the time axis by rendering, in the virtual space, a surface of the second three-dimensional structure using the content of the data stream.

### TECHNICAL FIELD

The inventive concept described herein is generally related to information visualization and, more particularly, to techniques pertaining to timeline-based three-dimensional visualization of video or file content with user participation.

### BACKGROUND

Unless otherwise indicated herein, approaches described in this section are not prior art to the claims listed below and are not admitted to be prior art by inclusion in this section.

The traditional way of viewing of a video, e.g., movie, typically involves one or more viewers passively viewing the video without a way for the viewer(s) to participate in the creation of the result(s). Besides, with the prevalence of electronic devices that may be used to create and/or store data files, often time a user would not re-use or review real-time video stream, live data and/or data files that have been created and stored.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, techniques, methods, apparatuses and systems allowing pre-existing or real-time data files of video, photograph, graphic and/or textual information to be used as material for games and/or creativity. Advantageously, implementations of the present disclosure allow a user to view the content of pre-existing or real-time data files of video, photograph, graphic and/or textual information in a participatory way, resulting in timeline-based three-dimensional visualization of the content of the data files of video, photograph, graphic and/or textual information.

In one aspect, a method may involve establishing, in a virtual space, a first three-dimensional structure representative of a content of a data stream. The first three-dimensional structure may have a time axis representative of a timeline. The method may also involve establishing, in the virtual space, a second three-dimensional structure representative of a model of a body of a user. The method may further involve displaying at least a first portion of the content of the data stream along the time axis by rendering, in the virtual space, a surface of the second three-dimensional structure using the content of the data stream.

In another aspect, a method may involve receiving a data stream. The method may involve establishing a three-dimensional model of a content of the data stream as a first structure in a virtual space by assigning a time axis to the content of the data stream. The method may also involve receiving a user input defining one aspect related to viewing of the content of the data stream. The method may further involve establishing a three-dimensional model or a depth image of a body of a user as a second structure in the virtual space. The method may additionally involve displaying at least a first portion of the content of the data stream corresponding to an intersection between the first structure and a surface of the second structure.

In yet another aspect, an apparatus may include a memory and a processor coupled to the memory. The memory may be configured to store one or more sets of instructions therein. The processor may execute the one or more sets of instructions to perform a number of operations. The operations may include establishing, in a virtual space, a first structure using a three-dimensional representation of a content of a data stream. The first structure may have a time axis representative of a timeline. The data stream may include a video stream, one or more photographs, one or more video files, one or more graphics files, one or more pieces of surface information, one or more textual files, one or more data files, live data, or a combination thereof. The operations may also include establishing, in the virtual space, a second structure representative of a three-dimensional model of a body of a user. The operations may further include displaying at least a first portion of the content of the data stream corresponding to an intersection between the first structure and a surface of the second structure.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example visualization in accordance with an implementation of the present disclosure.

FIG. 2 is a diagram of an example series of visualizations in accordance with an implementation of the present disclosure.

FIG. 3 is a diagram of an example operation utilized in various implementations of the present disclosure.

FIG. 4 is a diagram of another example operation utilized in various implementations of the present disclosure.

FIG. 5 is a diagram of yet another example operation utilized in various implementations of the present disclosure.

FIG. 6 is a diagram of still another example operation utilized in various implementations of the present disclosure.

FIG. 7 is a diagram of a further example operation utilized in various implementations of the present disclosure.

FIG. 8 is a diagram of an example algorithm in accordance with an implementation of the present disclosure.

FIG. 9 is an example apparatus in accordance with an implementation of the present disclosure.

FIG. 10 is a flowchart of an example process in accordance with an implementation of the present disclosure.

FIG. 11 is a flowchart of an example process in accordance with another implementation of the present disclosure.

### DETAILED DESCRIPTION OF PREFERRED IMPLEMENTATIONS

### Overview

In various implementations of the present disclosure, a first three-dimensional structure (herein interchangeably referred to as “structure 1”) may be established in a virtual space (herein interchangeably referred to as “space 1”) based on a data stream of video, photograph, graphic and/or textual information. One of the three axes of structure 1 may be a time axis representative of a timeline (herein interchangeably referred to as “timeline 1”). The other two axes of structure 1 may correspond to the content of the data stream. For example, in the context of the data stream including a video stream, which may be a live video stream or a pre-recorded video stream, each video frame of the video stream may be seen as being two-dimensional corresponding to a width axis and a height axis of structure 1. As another example, in the context of the data stream including a data file of multiple photographs, each photograph may also be seen as being two-dimensional corresponding to the width axis and the height axis of structure 1. In the above two examples, the multiple video frames or multiple photographs of the data stream may be conceptually “stacked up” along the time axis of structure 1, e.g., in a chronological order according to a respective point in time at which each video frame or photograph was taken, thereby forming the three dimensions of structure 1.

Additionally, a second three-dimensional structure (herein interchangeably referred to as “structure 2”) may be established in the virtual space. In a first scenario, structure 2 may simply be a three-dimensional structure constructed or otherwise established in the virtual space. In a second scenario, structure 2 may be a skeletal model of the user, and this may be done, for example, by using a depth image of the user captured by a depth camera. In the first scenario, structure 2 may be connected to at least a point on a skeletal model of the user or a depth image of the user such that a movement or a change in a posture of the user correspondingly causes a movement or a change in a posture of structure 2. In the second scenario, with structure 2 being based on the skeletal model or depth image of the user, any movement or change in posture of the user would cause a movement or a change in a posture of structure 2. For example, a real-life or pre-recorded image of the posture of the user in the real-world space (herein interchangeably referred to as “space 2”) may be transposed to space 1 to establish structure 2. In any event, structure 2 may be considered a dynamic representation of the user when it reflects the posture and movement of the user in space 2 in real time.

In various implementations of the present disclosure, the user may enter a command to rotate structure 1 in space 1, e.g., by making a machine-recognizable or otherwise predetermined movement of a body part. For example, the user may rotate a finger, hand, wrist or arm of the user as a machine-recognizable command to rotate structure 1. The rotation of structure 1 in space 1 may result in an angle difference, or a variation thereof, between the time axis of structure 1 and a depth axis z1 of space 1. In various implementations of the present disclosure, this angle difference may be applied to control a degree of difficulty or degree of predictability in terms of viewing the content of the data stream. For instance, the lesser the angle difference is, the lower degree of difficulty or the higher degree of predictability it may be for viewing the content of the data stream, and vice versa. Alternatively, the greater the angle difference is, the higher degree of difficulty or the lower degree of predictability it may be for viewing the content of the data stream, and vice versa.

In various implementations of the present disclosure, at least a portion of the content of the data stream along the time axis may be displayed for visualization of one or more portions of the content of the data stream. The displaying may involve rendering, in space 1, a surface of structure 2 using the content of the data stream. For example, at least a first portion of the content of the data stream corresponding to an intersection between structure 1 and a surface of structure 2 may be displayed. As another example, the surface of structure 2 may be rendered in space 1. Subsequently or simultaneously, a movement or a change in a posture of at least a portion of the body of the user may be detected, and thus a path of the movement or the change in the posture may be determined. Accordingly, one or more portions of the content of the data stream corresponding to an intersection between the path and the structure 1 may be displayed.

It is possible that there is no intersection between structure 1 and structure 2. In such case implementations of the present disclosure may still provide visualization of one or more portions of the content of the data stream. For instance, implementations of the present disclosure may replicate structure 1 (e.g., mirror image) and arrange it accordingly, so that the content corresponding to a given portion of structure 1 that does not intersect or overlap with structure 2 may be made to intersect or overlap with structure 2, and thereby may be displayed for visualization. Simply put, a given portion of structure 1 not intersecting or overlapping with structure 2 may be relocated or mirror imaged to another location so that it intersects or overlaps with structure 2 and may be displayed for visualization. Advantageously, this would not require additional memory loading.

Various implementations of the present disclosure allow the user to customize the visualization of the content of a data stream. By varying one or more of parameters in any combination, a variety of variations in the visualization of the content of the data stream may result due to the customization as the user actively participates in the process. The customizable parameters may include, for example and not limited to, (1) a data structure associated with the data stream regarding structure 1, (2) an angle difference between the time axis and the depth axis z1 (e.g., approximately 64,800 different angles may be possible in the angle difference in structure 1), (3) an imaging structure of structure 2 which may have a countless number of possible variations, and (4) an image timeline (herein interchangeably referred to as “timeline 2”) regarding establishing structure 2 using an image of the user, which may be considered limitless so long as the image of the user continues to be captured for dynamic construction of structure 2 and visualization of the content of the data stream.

In various implementations of the present disclosure, after structure 2 has been designed and established, structure 2 may be connected to a specific point on the skeletal model or a depth image of the user, e.g., a point that is closest to an imaging device or camera, and this would allow structure 2 to move corresponding to any movement of the body of the user. The use of depth image of the user enables implementing the techniques of the present disclosure when information of the skeletal model of the user is not available or the use thereof is not feasible.

In one example implementation, a spherical structure and a location of the palm of the skeletal model (or a most forward point in the depth image) may be connected. This way, when the arm of the user is stretched forward with the hand/palm moving in the air, the image of the user may be displayed as writing words or letters in the visualization. The strokes made by the user may cause the display of image of the content of selected data file(s), and this image may change as the position of the hand moves from one place to another. Accordingly, the longer the path of movement of the hand, the more of information from structure 1 may be displayed.

In another example implementation, the structure of clothing of the user may be added to the body of the user. For example, a sleeve of a shirt worn by the user may be connected to the skeletal model of the respective arm or a region corresponding to the arm in the depth image. This way, in the visualization structure 2 would appear to be wearing color-changing clothing with patterns on the clothing (from structure 1) varying according to movements of the user.

In another example implementation, a number of stacked squares (or other shapes) may be entered into space 1. The position of the depth of each square may be connected to a respective zone of the skeletal model or depth image, and thus a movement of the user in the forward-backward direction may move one or more of the squares to result in displacement in position of the squares, thereby resulting in reorganization in the display of the content of the data stream.

In view of the above, one with ordinary skill in the art would appreciate the potential of use of various implementations of the present disclosure. One example is that a game of hide-and-seek may be played to discover readable information (e.g., information from the same point in time). The user may create questions for others to find answers to, and may design the data structure of structure 1 to provide hint(s) to the questions. Difficulty in solving the questions may be controlled by adjusting the angle difference. The body of each player may be an intuitive tool for use, and throughout the game the system may detect the movement/posture of the player to correspondingly provide hints along timeline 2.

Another example is that a player may choose the content of interest for viewing by designing the structure of structure 1 to correspond to different movements and postures, so that whether or not structure 2 is properly positioned may be easily and quickly determined. With the player constantly moving and/or changing the posture thereof, variation in the image being displayed in real time along timeline 2 would make the process interesting and fun.

A further example is that creative images may be created with the generation of meaningful sequence of images along a timeline. This is especially so given that the user-defined parameters allow the user to produce customizable results of visualization according to the personal design of the user.

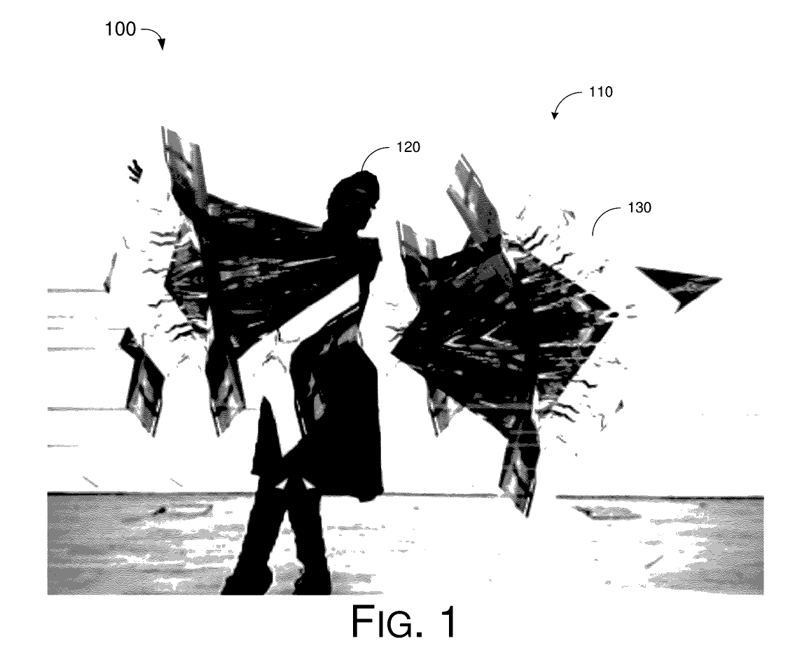

FIG. 1 illustrates an example visualization 100 in accordance with an implementation of the present disclosure. Example visualization 100 may be displayed or otherwise presented by a display device (e.g., a display panel, monitor or screen associated with a computer, or three-dimensional display such as holographic display, Hololens, Oculus and the like) for viewing. As shown in FIG. 1, example visualization 100 shows, in a virtual space 110, an image 120 of the user and a visualization 130 of one or more portions of the content of data stream.

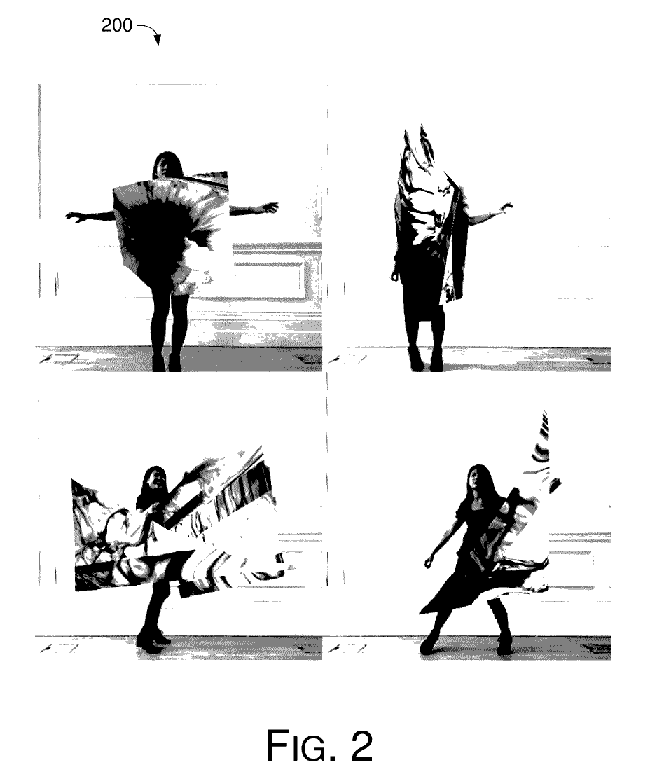

FIG. 2 illustrates an example series 200 of visualizations in accordance with an implementation of the present disclosure. Example series 200 of visualization may be displayed or otherwise presented by a display device, e.g., a display panel, monitor or screen associated with a computer, for viewing. As shown in FIG. 2, example series 200 of visualization includes a number of visualizations, similar to example visualization 100, shown in a virtual space with an image of the user, in different motions and/or postures, and the resultant visualization of one or more portions of the content of data stream.

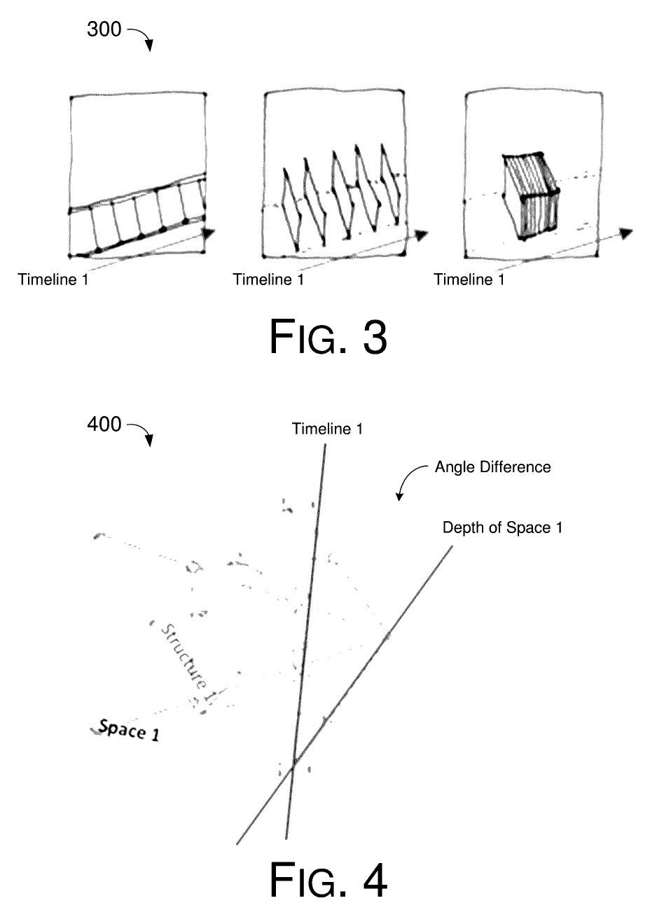

FIG. 3 illustrates an example operation 300 utilized in various implementations of the present disclosure. In example operation 300, a three-dimensional model of structure 1 is generated, established or otherwise constructed. As shown in FIG. 3, multiple video frames, multiple photographs or multiple pages of a data file may be conceptually “stacked up” along timeline 1, or the time axis of structure 1, in a chronological order according to a respective point in time at which each video frame, photograph or page was created, to establish or otherwise construct the three dimensions of structure 1.

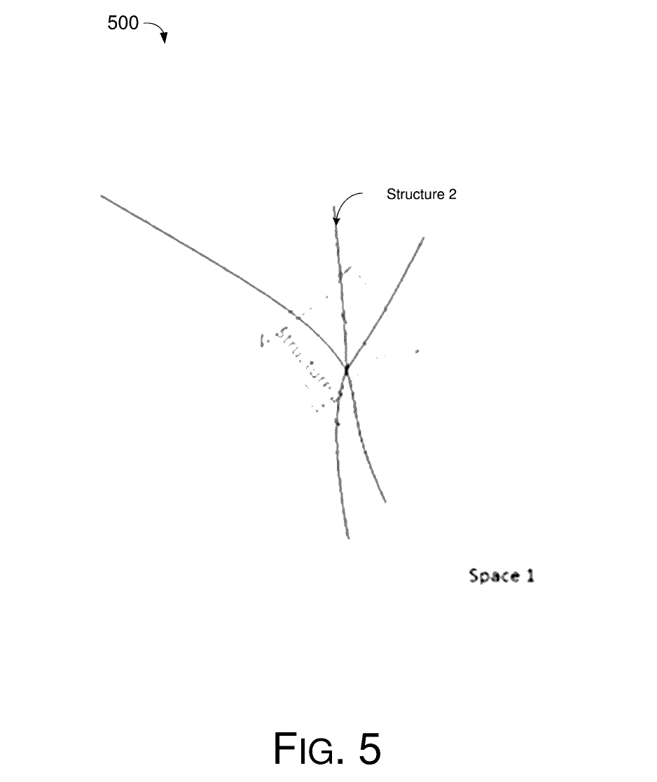

FIG. 4 illustrates an example operation 400 utilized in various implementations of the present disclosure. In example operation 400, the user rotates a hand as a command to rotate structure 1. This allows the user to cause or otherwise set an angle difference (herein referred to as “angle difference 1”) between structure 1 and space 1, i.e., the angle difference between the time axis, timeline 1, and the depth axis z1 of space 1. This angle difference may be used to control a degree of difficulty or degree of predictability in terms of viewing the content of the data stream. In mathematical terms, a relation between a point P1 in structure 1 and a point P2 in space 1 may be expressed as P2=R*P1, where R is a rotational matrix computed from a rotation between the hand and shoulder of the user.

FIG. 5 illustrates an example operation 500 utilized in various implementations of the present disclosure. In example operation 500, a skeletal model of the user, e.g., the body or a body part (e.g., hand(s), finger(s), arm(s), leg(s) and/or head) thereof, is detected and used to generate, establish or otherwise construct the three-dimensional model of structure 2. The position and posture of structure 2 in space 1 corresponds to the position and posture of the skeletal model of the user in space 2. In mathematical terms, with the position P3 of the user in space 2 captured by a video camera and the skeletal model of the user transposed (T) and shrunk (S) to be placed at position P4 in space 1, the relation between P4, P3, S and T may be expressed as P4=S*(P3−T).

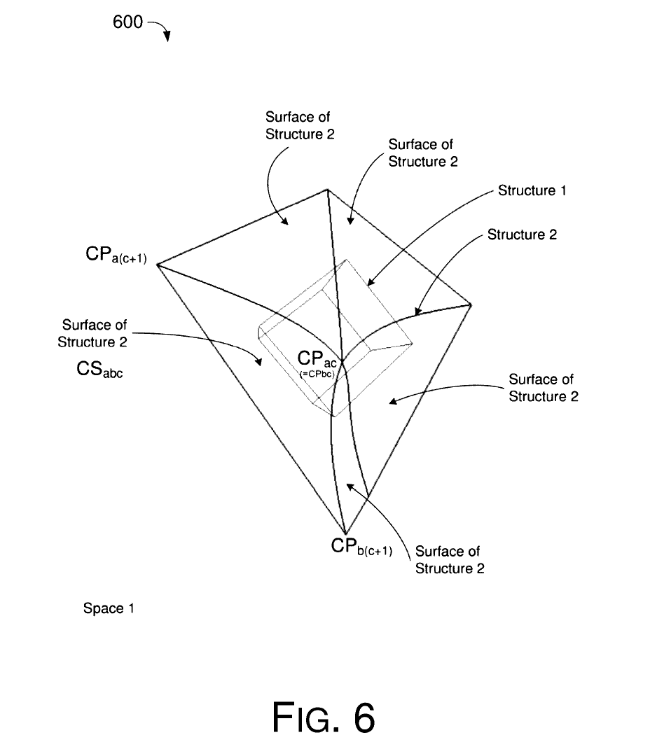

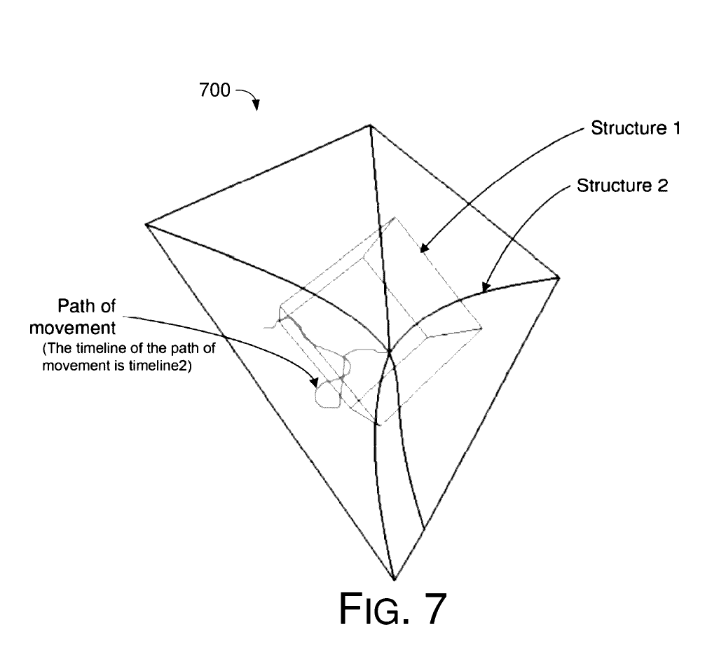

FIG. 6 illustrates an example operation 600 utilized in various implementations of the present disclosure. In example operation 600, by rendering the surface of structure 2, the content of the data stream from various points in time based on timeline 1 may be synchronously displayed or otherwise visualized. The visualization may include twisted image(s) of the content of the data stream as well as dynamically changing outer frame(s) of the image(s). In some implementations, a depth camera may be used to detect the locations of multiple points or joints on the skeletal model of the user, e.g., 15 points or joints, with the multiple points or joints respectively connected to one another to form five lines or curves C1-C5. A number of sample points, CPᵢⱼ with the value of i being between 1 and 5, may be taken along each of the five lines or curves. Sample points on two adjacent lines or curves may be connected to form surfaces. For example, surface CS_{abc} may be formed by connecting the three sample points of CP_{ac} (=CP_{bc}), CP_{b(c+1)}, CP_{a(c+1)}.

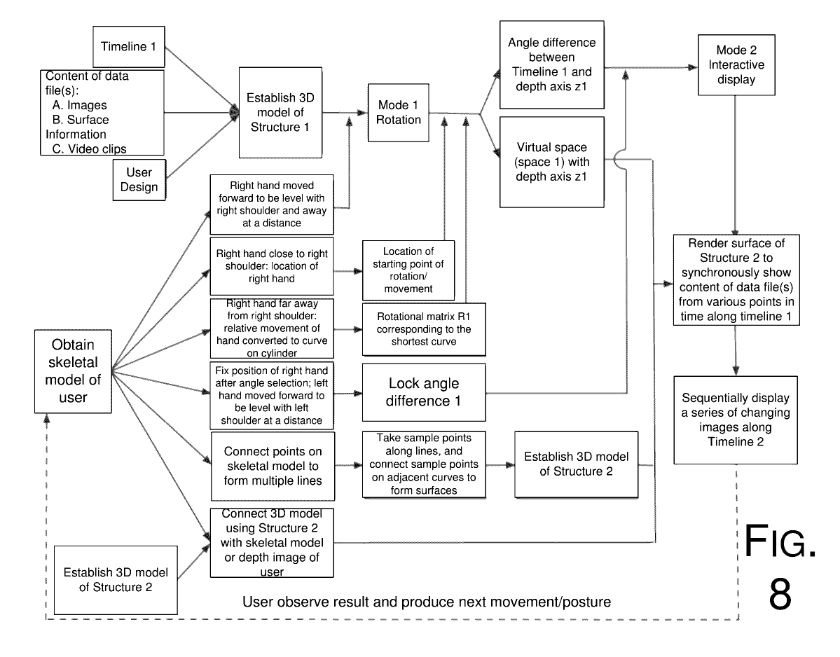

FIG. 7 illustrates an example operation 700 utilized in various implementations of the present disclosure. In example operation 700, any motion and/or any change in position of the user may be detected in real time and correspondingly cause a change in the structure and/or position of structure 2. Over time a series of changing images along the image timeline, timeline 2, may be sequentially displayed for visualization.

FIG. 8 illustrates an example algorithm 800 in accordance with an implementation of the present disclosure. Referring to example algorithm 800, user design (e.g., in the form of one or more user-defined parameters), the time axis representative of timeline 1, and content of data stream such as live video stream, live data, data files, images, surface information and/or video clips, may be taken as input to establish the three-dimensional model of structure 1. The skeletal model of a user may be detected and utilized in a variety of ways. For example, when the right hand of the user is raised to be level with the right shoulder of the user and away at a certain distance from the right shoulder, this posture of the user may be taken as a command to enter into a first mode, mode 1, to rotate structure 1. When structure 1 is rotated, an angle difference between timeline 1 and depth axis z1 of space 1 may be formed. Subsequently, a second mode, mode 2, may be entered for interactive display. When the right hand of the user is close to the right shoulder of the user, the location of the right hand may be taken as the starting point for rotation or movement of structure 1. When the right hand of the user is far away from the right shoulder of the user, a relative movement of the hand may be converted to a curve on a cylindrical model. A rotational matrix R1, based on a rotation between the hand and shoulder of the user, may correspond to a shorted curve among multiple curves. If the right hand of the user is stationary after an angle is selected, the left hand of the user may move forward to be level with the left shoulder of the user and away from the left shoulder at a distance. The angle difference at that moment, or angle difference 1, may be locked and used as input for entry into mode 2. Additionally, points on a skeletal model of the user may be connected to form multiple lines. Sample points along the multiple lines may be taken, and sample points on adjacent two lines may be connected to form surfaces. Accordingly, the three-dimensional model of structure 2 may be established or otherwise constructed. Alternatively, a three-dimensional model may be independently established or otherwise constructed in space 1 as structure 2, and be connected with the skeletal model or depth image of the user. By rendering the surface of structure 2, with space 1 (having depth axis z1) and structure 2 as input, the content of the data stream from various points in time may be displayed for visualization. A series of changing images along timeline 2 may be displayed sequentially. As the user observes the result of visualization, the user may decide to produce the next movement and/or posture, and the above-described process continues.

### Example Implementations

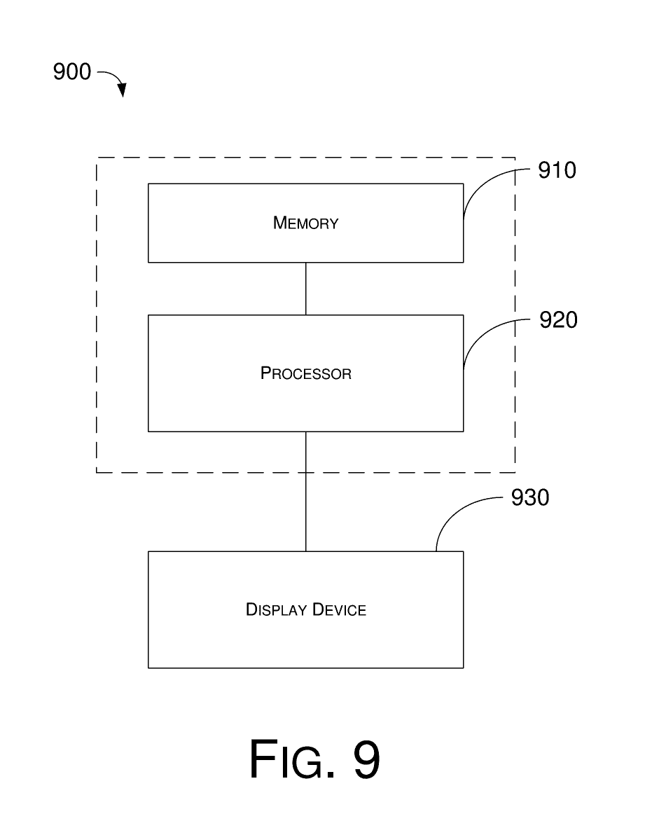

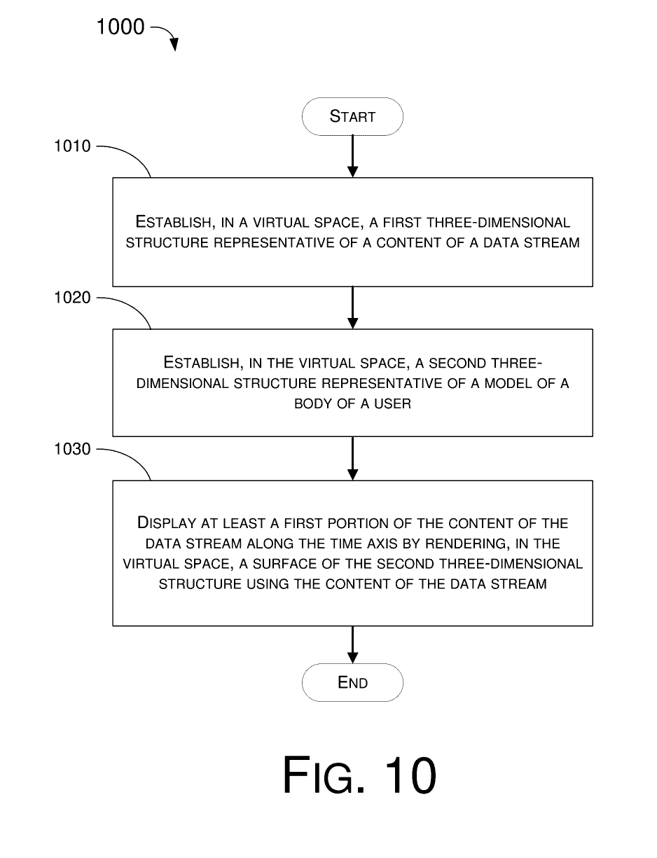

FIG. 9 is a block diagram of an example apparatus 900 in accordance with an implementation of the present disclosure. Example apparatus 900 may perform various operations and functions related to techniques, methods and systems described herein, including example operations 300, 400, 500, 600 and 700 and example algorithm 800 described above as well as example processes 1000 and 1100 described below. In some implementations, example apparatus 900 may be a portable electronics apparatus such as, for example, a smartphone, a personal digital assistant (PDA), a camera, a camcorder or a computing device such as a tablet computer, a laptop computer, a notebook computer, a wearable device and the like, which is equipped with a graphics processing device. In such case, example apparatus 900 may include at least those components shown in FIG. 9, such as a memory 910 and a processor 920. Optionally, example apparatus 900 may additionally include a display device 930. Although memory 910, processor 920 and display device 930 are illustrated in FIG. 9 as discrete components separate from each other, in various embodiments of example apparatus 900 some or all of memory 910, processor 920 and processor 920 may be integral parts of a single integrated circuit (IC), chip or chipset. For instance, in some implementations memory 910 and processor 920 may be integral parts of a single chip or chipset.

In some other implementations, example apparatus 900 may be, for example, a processor in the form of an IC, chip, chipset or an assembly of one or more chips and a PCB, which may be implementable in a portable electronics apparatus such as, for example, a smartphone, a PDA, a camera, a camcorder or a computing device such as a tablet computer, a laptop computer, a notebook computer, a wearable device and the like, which is equipped with a graphics processing device.

Memory 910 may be configured to store one or more sets of processor-executable instructions therein. For example, memory 910 may store one or more sets of instructions that, upon execution by processor 920, may cause processor 920 to perform example operations 300, 400, 500, 600 and 700 and example algorithm 800 as well as operations of example processes 1000 and 1100. The one or more sets of processor-executable instructions may be firmware, middleware, software or any combination thereof. Memory 910 may also be configured to store a data stream therein. For example, memory 910 may store the content of data stream of video, photograph, graphic and/or textual information.

Memory 910 may be in the form of any combination of one or more computer-usable or non-transitory computer-readable media. For example, memory 910 may be in the form of one or more of a removable computer diskette, a hard disk, a random access memory (RAM) device, a read-only memory (ROM) device, an erasable programmable read-only memory (EPROM or Flash memory) device, a removable compact disc read-only memory (CDROM), an optical storage device, a magnetic storage device, or any suitable storage device. Computer program code for carrying out operations of the present disclosure may be written in any combination of one or more programming languages. Such code, or processor-executable instruction, may be compiled from source code to computer-readable assembly language or machine code suitable for the device or computer on which the code will be executed.

Processor 920 may be coupled to memory 910 to access the one or more sets of processor-executable instructions and any data stored therein. Upon executing the one or more sets of processor-executable instructions, processor 920 may perform a number of operations in accordance with the present disclosure. For example, processor 920 may establish, in a virtual space, a first structure using a three-dimensional representation of a content of a data stream. The first structure may have a time axis representative of a timeline. The data stream may include a video stream, one or more photographs, one or more video files, one or more graphics files, one or more pieces of surface information, one or more textual files, one or more data files, live data, or a combination thereof. Processor 920 may also establish, in the virtual space, a second structure representative of a three-dimensional model of a body of a user. Processor 920 may further provide one or more signals that, upon receipt by a display device, e.g., display device 930, cause the display device to display at least a first portion of the content of the data stream corresponding to an intersection between the first structure and a surface of the second structure. Display device 930 may be, for example, a display panel, monitor, screen or three-dimensional display (e.g., holographic display, Hololens or Oculus).

In at least some implementations, processor 920 may be configured to perform further operations. For example, processor 920 may detect a rotation of a portion of the body of the user. Processor 920 may also adjust an angle difference between the time axis and a depth axis of the virtual space based at least in part on an angle of the rotation. Processor 920 may further set a degree of difficulty or predictability of viewing of the content of the data stream based at least in part on the angle difference.

In at least some implementations, in providing the one or more signals, processor 920 may be configured to provide the one or more signals that, upon receipt by display device 930, cause display device 930 to display at least the first portion of the content of the data stream based at least in part on one or more user-defined parameters. The one or more user-defined parameters may include, for example and not limited to, a data structure associated with the data stream regarding the first structure, an angle difference between the time axis and the depth axis, an imaging structure of the second structure, and an image timeline regarding establishing the second structure.

In at least some implementations, in providing the one or more signals, processor 920 may be configured to perform a number of operations as described below. Processor 920 may render the surface of the second structure. Processor 920 may also detect a movement or a change in a posture of at least a portion of the body of the user. Processor 920 may further determine a path of the movement or the change in the posture. Processor 920 may additionally provide the one or more signals that, upon receipt by display device 930, cause display device 930 to display one or more portions of the content of the data stream corresponding to an intersection between the path and the first structure.

In at least some implementations, processor 920 may be further configured to connect, in the virtual space, the second structure to at least a point on a skeletal model of the user or a depth image of the user such that a movement or a change in a posture of the user correspondingly causes a movement or a change in a posture of the second structure.

FIG. 10 illustrates an example process 1000 in accordance with an implementation of the present disclosure. Example process 1000 may include one or more operations, actions, or functions as illustrated by one or more of blocks 1010, 1020 and 1030. Although illustrated as discrete blocks, various blocks may be divided into additional blocks, combined into fewer blocks, or eliminated, depending on the desired implementation. Example process 1000 may be implemented by example apparatus 1000, and may perform some or all of example operations 300, 400, 500, 600 and 700 and example algorithm 800 as well as variations thereof. For illustrative purposes, the operations described below with respect to example process 1000 are performed by example apparatus 900 in the context of example scenario 100, example scenarios 200, example operations 300-700 and example algorithm 800. Example process 1000 may begin at block 1010.

At 1010, example process 1000 may involve example apparatus 900 establishing, in a virtual space, a first three-dimensional structure representative of a content of a data stream, the first three-dimensional structure having a time axis representative of a timeline. Block 1010 may be followed by block 1020.

At 1020, example process 1000 may involve example apparatus 900 establishing, in the virtual space, a second three-dimensional structure representative of a model of a body of a user. Block 1020 may be followed by block 1030.

At 1030, example process 1000 may involve example apparatus 900 displaying at least a first portion of the content of the one or more data files along the time axis by rendering, in the virtual space, a surface of the second three-dimensional structure using the content of the data stream.

In at least some implementations, the data stream may include a video stream, one or more photographs, one or more video files, one or more graphics files, one or more pieces of surface information, one or more textual files, one or more data files, live data, or a combination thereof.

In at least some implementations, in displaying at least the first portion of the content of the data stream along the time axis by rendering, in the virtual space, the surface of the second three-dimensional structure using the content of the data stream, example process 1000 may involve example apparatus 900 displaying one or more portions of the content of the data stream corresponding to one or more portions of the first three-dimensional structure that intersect with the surface of the second three-dimensional structure.

In at least some implementations, in displaying at least the first portion of the content of the data stream along the time axis, example process 1000 may involve example apparatus 900 displaying one or more portions of the content of the data stream based at least in part on one or more user-defined parameters.

In at least some implementations, the one or more user-defined parameters may include a data structure associated with the data stream regarding the first structure, an angle difference between the time axis and the depth axis, an imaging structure of the second structure, and an image timeline regarding establishing the second structure.

In at least some implementations, example process 1000 may also involve example apparatus 900 determining an angle difference between the time axis and the depth axis. In displaying at least the first portion of the content of the data stream along the timeline, example process 1000 may involve example apparatus 900 displaying one or more portions of the content of the data stream at multiple points in time along the time axis based at least in part on the angle difference.

In at least some implementations, example process 1000 may also involve example apparatus 900 detecting a movement or a change in a posture of at least a portion of the body of the user. Additionally, example process 1000 may further involve example apparatus 900 displaying at least a second portion of the content of the data stream along the time axis in response corresponding to the movement or the change in the posture.

In at least some implementations, example process 1000 may also involve example apparatus 900 connecting, in the virtual space, the second three-dimensional structure to at least a point on a skeletal model of the user or a depth image of the user such that a movement or a change in a posture of the user correspondingly causes a movement or a change in a posture of the second three-dimensional structure.

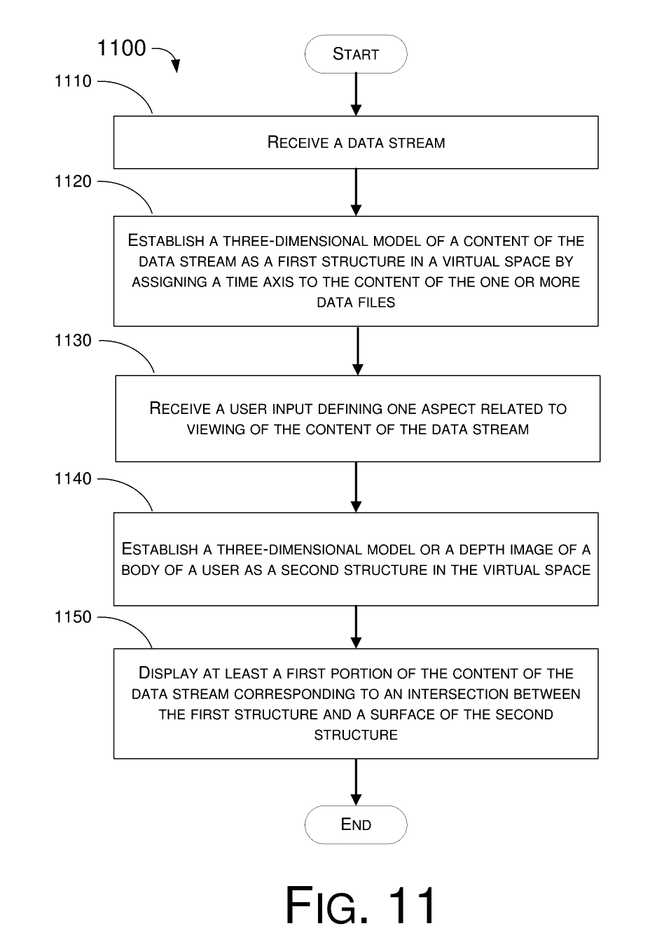

FIG. 11 illustrates an example process 1100 in accordance with an implementation of the present disclosure. Example process 1100 may include one or more operations, actions, or functions as illustrated by one or more of blocks 1110, 1120 and 1130. Although illustrated as discrete blocks, various blocks may be divided into additional blocks, combined into fewer blocks, or eliminated, depending on the desired implementation. Example process 1100 may be implemented by example apparatus 1100, and may perform some or all of example operations 300, 400, 500, 600 and 700 and example algorithm 800 as well as variations thereof. For illustrative purposes, the operations described below with respect to example process 1100 are performed by example apparatus 900 in the context of example scenario 100, example scenarios 200, example operations 300-700 and example algorithm 800. Example process 1100 may begin at block 1110.

At 1110, example process 1100 may involve example apparatus 900 receiving a data stream. Block 1110 may be followed by block 1120.

At 1120, example process 1100 may involve example apparatus 900 establishing a three-dimensional model of a content of the data stream as a first structure in a virtual space by assigning a time axis to the content of the data stream. Block 1120 may be followed by block 1130.

At 1130, example process 1100 may involve example apparatus 900 receiving a user input defining one aspect related to viewing of the content of the data stream. Block 1130 may be followed by block 1140.

At 1140, example process 1100 may involve example apparatus 900 establishing a three-dimensional model or a depth image of a body of a user as a second structure in the virtual space. Block 1140 may be followed by block 1150.

At 1150, example process 1100 may involve example apparatus 900 displaying at least a first portion of the content of the data stream corresponding to an intersection between the first structure and a surface of the second structure.

In at least some implementations, the data stream may include a video stream, one or more photographs, one or more video files, one or more graphics files, one or more pieces of surface information, one or more textual files, one or more data files, live data, or a combination thereof.

In at least some implementations, in receiving the user input defining one aspect related to the viewing of the content of the data stream, example process 1100 may involve example apparatus 900 performing a number of operations. For example, example process 1100 may involve example apparatus 900 detecting a rotation of a portion of the body of the user. Example process 1100 may also involve example apparatus 900 adjusting an angle difference between the time axis and a depth axis of the virtual space based at least in part on an angle of the rotation. Example process 1100 may further involve example apparatus 900 setting a degree of difficulty or predictability of viewing of the content of the data stream based at least in part on the angle difference.

In at least some implementations, in displaying at least the first portion of the content of the data stream, example process 1100 may involve example apparatus 900 displaying one or more portions of the content of the data stream based at least in part on one or more user-defined parameters.

In at least some implementations, the one or more user-defined parameters may include a data structure associated with the data stream regarding the first structure, an angle difference between the time axis and the depth axis, an imaging structure of the second structure, and an image timeline regarding establishing the second structure.

In at least some implementations, in displaying at least the first portion of the content of the data stream corresponding to the intersection between the first structure and the surface of the second structure, example process 1100 may involve example apparatus 900 performing a number of operations. For example, example process 1100 may involve example apparatus 900 rendering the surface of the second structure. Example process 1100 may also involve example apparatus 900 detecting a movement or a change in a posture of at least a portion of the body of the user. Example process 1100 may further involve example apparatus 900 determining a path of the movement or the change in the posture. Example process 1100 may additionally involve example apparatus 900 displaying one or more portions of the content of the data stream corresponding to an intersection between the path and the first structure.

In at least some implementations, example process 1100 may further involve example apparatus 900 connecting, in the virtual space, the second structure to at least a point on a skeletal model of the user or a depth image of the user such that a movement or a change in a posture of the user correspondingly causes a movement or a change in a posture of the second structure.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
establishing, in a virtual space, a first three-dimensional structure representative of a content of a data stream, the first three-dimensional structure having a time axis representative of a timeline;
establishing, in the virtual space, a second three-dimensional structure representative of a model of a body of a user; and
displaying at least a first portion of the content of the data stream along the time axis by rendering, in the virtual space, a surface of the second three-dimensional structure using the content of the data stream.

2. The method of claim 1, wherein the data stream comprise a video stream, one or more photographs, one or more video files, one or more graphics files, one or more pieces of surface information, one or more textual files, one or more data files, live data, or a combination thereof.

3. The method of claim 1, wherein the displaying of at least the first portion of the content of the data stream along the time axis by rendering, in the virtual space, the surface of the second three-dimensional structure using the content of the data stream comprises displaying one or more portions of the content of the data stream corresponding to one or more portions of the first three-dimensional structure that intersect with the surface of the second three-dimensional structure.

4. The method of claim 1, wherein the displaying of at least the first portion of the content of the data stream along the time axis comprises displaying one or more portions of the content of the data stream based at least in part on one or more user-defined parameters.

5. The method of claim 4, wherein the one or more user-defined parameters comprise a data structure associated with the data stream regarding the first three-dimensional structure, an angle difference between the time axis and a depth axis of the virtual space, an imaging structure of the second three-dimensional structure, and an image timeline regarding the establishing of the second three-dimensional structure.

6. The method of claim 1, further comprising:
determining an angle difference between the time axis and a depth axis of the virtual space, wherein the displaying of at least the first portion of the content of the data stream along the timeline comprises displaying one or more portions of the content of the data stream at multiple points in time along the time axis based at least in part on the angle difference.

7. The method of claim 1, further comprising:
detecting a movement or a change in a posture of at least a portion of the body of the user; and
displaying at least a second portion of the content of the data stream along the time axis in response corresponding to the movement or the change in the posture.

8. The method of claim 1, further comprising:
connecting, in the virtual space, the second three-dimensional structure to at least a point on a skeletal model of the user or a depth image of the user such that a movement or a change in a posture of the user correspondingly causes a movement or a change in a posture of the second three-dimensional structure.

9. A method, comprising:
receiving a data stream;
establishing a three-dimensional model of a content of the data stream as a first structure in a virtual space by assigning a time axis to the content of the data stream;
receiving a user input defining one aspect related to viewing of the content of the data stream;
establishing a three-dimensional model or a depth image of a body of a user as a second structure in the virtual space; and
displaying at least a first portion of the content of the data stream corresponding to an intersection between the first structure and a surface of the second structure.

10. The method of claim 9, wherein the data stream comprise a video stream, one or more photographs, one or more video files, one or more graphics files, one or more pieces of surface information, one or more textual files, one or more data files, live data, or a combination thereof.

11. The method of claim 9, wherein the receiving of the user input defining one aspect related to the viewing of the content of the data stream comprises:
detecting a rotation of a portion of the body of the user;
adjusting an angle difference between the time axis and a depth axis of the virtual space based at least in part on an angle of the rotation; and
setting a degree of difficulty or predictability of viewing of the content of the data stream based at least in part on the angle difference.

12. The method of claim 9, wherein the displaying of at least the first portion of the content of the data stream comprises displaying one or more portions of the content of the data stream based at least in part on one or more user-defined parameters.

13. The method of claim 12, wherein the one or more user-defined parameters comprise a data structure associated with the data stream regarding the first structure, an angle difference between the time axis and a depth axis of the virtual space, an imaging structure of the second structure, and an image timeline regarding the establishing of the second structure.

14. The method of claim 9, wherein the displaying of at least the first portion of the content of the data stream corresponding to the intersection between the first structure and the surface of the second structure comprises:
rendering the surface of the second structure;
detecting a movement or a change in a posture of at least a portion of the body of the user;
determining a path of the movement or the change in the posture; and
displaying one or more portions of the content of the data stream corresponding to an intersection between the path and the first structure.

15. The method of claim 9, further comprising:
connecting, in the virtual space, the second structure to at least a point on a skeletal model of the user or a depth image of the user such that a movement or a change in a posture of the user correspondingly causes a movement or a change in a posture of the second structure.

16. An apparatus, comprising:
a memory configured to store one or more sets of instructions; and
a processor coupled to the memory, the processor configured to execute the one or more sets of instructions to perform operations comprising:
establishing, in a virtual space, a first structure using a three-dimensional representation of a content of a data stream;
establishing, in the virtual space, a second structure representative of a three-dimensional model of a body of a user; and
providing one or more signals that, upon receipt by a display device, cause the display device to display at least a first portion of the content of the data stream corresponding to an intersection between the first structure and a surface of the second structure.

17. The apparatus of claim 16, wherein the processor is further configured to perform operations comprising:
detecting a rotation of a portion of the body of the user;
adjusting an angle difference between the time axis and a depth axis of the virtual space based at least in part on an angle of the rotation; and
setting a degree of difficulty or predictability of viewing of the content of the data stream based at least in part on the angle difference.

18. The apparatus of claim 16, wherein, in providing the one or more signals, the processor is configured to provide the one or more signals that, upon receipt by the display device, cause the display device to display at least the first portion of the content of the data stream based at least in part on one or more user-defined parameters comprising a data structure associated with the data stream regarding the first structure, an angle difference between the time axis and a depth axis of the virtual space, an imaging structure of the second structure, and an image timeline regarding the establishing of the second structure, wherein the first structure includes a time axis representative of a timeline, and wherein the data stream comprises a video stream, one or more photographs, one or more video files, one or more graphics files, one or more pieces of surface information, one or more textual files, one or more data files, live data, or a combination thereof.

19. The apparatus of claim 16, wherein, in providing the one or more signals, the processor is configured to perform operations comprising:
rendering the surface of the second structure;
detecting a movement or a change in a posture of at least a portion of the body of the user;
determining a path of the movement or the change in the posture; and
providing the one or more signals that, upon receipt by the display device, cause the display device to display one or more portions of the content of the data stream corresponding to an intersection between the path and the first structure.

20. The apparatus of claim 16, wherein the processor is further configured to perform operations comprising:
connecting, in the virtual space, the second structure to at least a point on a skeletal model of the user or a depth image of the user such that a movement or a change in a posture of the user correspondingly causes a movement or a change in a posture of the second structure.
